(19) United States
(12) Patent Application Publication
(10) Pub. No.: US 2025/0199764 A1
(43) Pub. Date: Jun. 19, 2025

(54) PARALLEL DETERMINISTIC STOCHASTIC ROUNDING

(71) Applicant: NVIDIA Corporation, Santa Clara, CA (US)

(72) Inventors: Qinglong Chang, Shanghai (CN); Shijiang Yu, Shanghai (CN)

(21) Appl. No.: 18/545,352

(22) Filed: Dec. 19, 2023

(51) Int. Cl. G06F 7/499; G06F 7/58

(52) U.S. Cl. CPC G06F 7/49947; G06F 7/584; G06F 2207/581

(57) ABSTRACT

Disclosed are systems and techniques for parallel deterministic stochastic rounding. In one embodiment, the techniques include obtaining a first set of values of a first bit-length and a second set of values of the first bit-length and generating a third set of values of a second bit-length. Each value of the third set of values is a lower precision value of a corresponding value of the first set of values. The techniques include generating a fourth set of values of the second bit-length, and each value of the fourth set of values is a lower precision value of a corresponding value of the second set of values. Generating the third set of values and the fourth set of values is performed in parallel.

### TECHNICAL FIELD

At least one embodiment pertains to computational technologies used to perform and facilitate deterministic stochastic rounding in parallel. For example, at least one embodiment pertains to operations that reduce visual artifacts caused by pixel bit-depth reduction. At least one embodiment pertains to operations that increase accuracy of neural network weights following a bit-depth reduction.

### BACKGROUND

A video file in a raw (source) pixel format can occupy a very large memory space and require a large network bandwidth for transmission, which can be impractical for storage and/or livestreaming. One way to reduce the memory space required is to reduce the amount of information stored for each pixel of the video file. For example, a video file that represents each pixel using 10 bits of data will require more memory space than a video file that represents each pixel using 8 bits of data.

Similarly, the weights of a neural network can occupy a very large memory space and require a large network bandwidth for transmission, which can be impractical for storage. One way to reduce the memory space required is to reduce the bit-length of each weight of the neural network. For example, 16-bit neural network weights will require more memory space than 8-bit neural network weights.

### BRIEF DESCRIPTION OF DRAWINGS

FIG. 1 is a schematic block diagram of an example system for deterministic stochastic rounding in parallel, in accordance with at least some embodiments;

FIG. 2 is a schematic block diagram of an example pseudo-random number generator for parallel, deterministic stochastic rounding, in accordance with at least some embodiments;

FIG. 3 is a schematic block diagram of a linear-feedback shift register of the pseudo-random number generator of FIG. 2, in accordance with at least some embodiments;

FIG. 4A is a block diagram of regions of a video frame to be processed in parallel, in accordance with at least some embodiments;

FIG. 4B is a block diagram of layers of a neural network whose weights are to be processed in parallel, in accordance with at least some embodiments; and

FIG. 5 is a flow diagram of an example method of performing deterministic stochastic rounding, in accordance with at least some embodiments.

### DETAILED DESCRIPTION

When reducing the bit-length of a value, a decision needs to be made regarding how to round the resulting number. For example, the resulting number can be not rounded at all, rounded half away from zero, rounded half to even, etc. A rounding error can be calculated by comparing the resulting number to the original number. After rounding a set of values (e.g., pixels of a region of an image or video frame, neural network weights of a layer of a neural network, etc.) some rounding methods result in an accumulation of errors. Some rounding methods (e.g., rounding half away from zero) result in an accumulation of errors for any dataset, whereas other rounding methods (e.g., rounding half to even) result in an accumulation of errors for datasets with values that are not uniformly distributed. These accumulated rounding errors can lead to visual artifacts (e.g., banding) during video processing and can lead to less accurate neural network results while using the neural network during an inference phase.

Additionally, to process a video frame (or image) efficiently (e.g., to efficiently convert all the pixel values of a video frame from a high bit-depth to a low bit-depth), the image is often broken up into one or more blocks. Since some rounding methods depend on neighboring values and/or on the currently accumulated error, the blocks need to be processed sequentially, decreasing throughput and processing speed.

Aspects and embodiments of the present disclosure address these and other technological challenges of eliminating rounding errors by providing for systems and techniques that perform deterministic stochastic rounding in parallel. Stochastic rounding does not lead to an accumulation of errors (for neither uniformly distributed values nor for non-uniformly distributed values) and depends upon a random number generator. In some embodiments, to ensure a deterministic result, the seed for the random number generator is determined based on the region of the video frame being processed. For example, the video frame may be divided into a set of blocks, each block corresponding to a region of the video frame. Based on the position of the block in the video frame, a seed value may be determined for the random number generator. In some embodiments, the seed for the random number generator is determined based on the layer of the neural network that is being processed. For example, the neural network may include a set of ordered layers with corresponding weights. Based on the position of the layer in the set of ordered layers, a seed value may be determined for the random number generator.

Each value of the set of values to be processed (e.g., each pixel value in a block of a video frame, each neural network weight value in a layer of a neural network, etc.) may be rounded sequentially. Each value may be split into two sets of bits: the rounded bits and the truncated bits. The truncated bits may be the least significant bits of the value, and the number of bits to be truncated may be equal to the difference between the high bit-depth value and the low bit-depth value. The remaining bits are included in the rounded bits. For example, if the bit-depth of the set of values being processed is being reduced from 10 bits to 8 bits, the truncated bits would be the 2 least significant bits of the original value, and the rounded bits would be the 8 most significant bits of the original value. Similarly, if the bit-depth of the set of values being processed is being reduced from 16 bits to 8 bits, the truncated bits would be the 8 least significant bits of the original value, and the rounded bits would be the 8 most significant bits of the original value.

The value may be rounded based on the output of the random number generator. For example, if the value of the truncated bits is greater than the output of the random number generator, the rounded bits may be rounded away from zero. If the value of the truncated bits is less than or equal to the output of the random number generator, the rounded bits may be rounded toward zero. Because of the uniform distribution of the output of the random number generator, there will be no accumulation of rounding errors in the set of values to be processed. Because there are no dependencies between neighboring values or accumulated errors, multiple sets of values can be processed in parallel.

For example, in some embodiments, a first block of a video frame and a second block of the video frame may be processed in parallel. A first random number generator seed may be determined for the first block based on the position of the block in the video frame and a second random number generator seed may be determined for the second block based on the position of the block in the video frame. A first random number generator may be used to process the first block and a second random number generator may be used to process the second block.

In some embodiments, neural network weights of a first layer of a neural network and neural network weights of a second layer of the neural network may be processed in parallel. A first random number generator seed may be determined based on the position of the first layer in the ordered layers of the neural network, and a second random number generator seed may be determined based on the position of the second layer in the ordered layers of the neural network. A first random number generator may be used to process the first block, and a second random number generator may be used to process the second block.

Advantages of the disclosed embodiments over the existing technology include reduced rounding errors and increased throughput of value processing as values are processed in parallel. The reduced rounding errors can eliminate visual artifacts (e.g., banding) in video processing and can increase accuracy of neural network outputs generated during an inference phase of the neural network.

### System Architecture

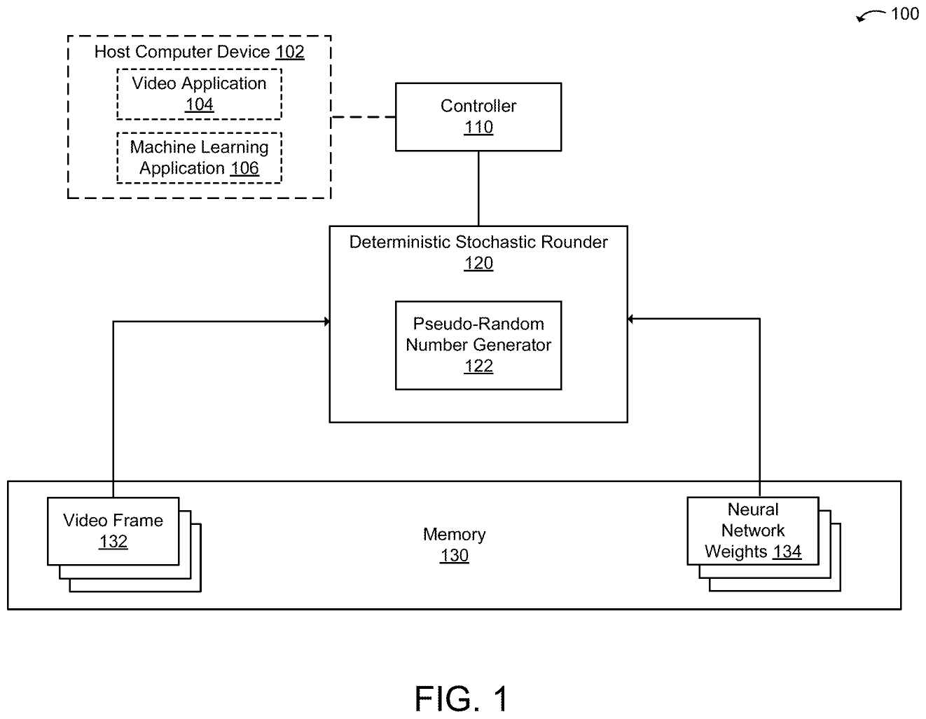

FIG. 1 is a schematic block diagram of an example system 100 for deterministic stochastic rounding in parallel, in accordance with at least some embodiments. System 100 may be a part of or in communication with a host computer device 102, which may be a desktop computer, a laptop computer, a smartphone, a tablet computer, a local server, a cloud server, a dedicated video processing server, a collection of multiple computing devices, a distributed computing system, a smart TV, an augmented reality device, or any other suitable computing device (or collection of computing devices) capable of performing the techniques described herein. Host computer device 102 may include one or more applications, including a video application 104, which may be any application capable of creating or managing video files, and/or a machine learning application 106, which may be any application capable of creating or managing machine learning models. For example, video application 104 may be a video camera application, a video gaming application, a movie-making application, a video-streaming application, a social-networking application, or any other application that may create, render, download, receive, and/or process video files, including but not limited to high-definition video files. Machine learning application 106 may be an application for training machine learning models and/or performing inference using a trained machine learning model.

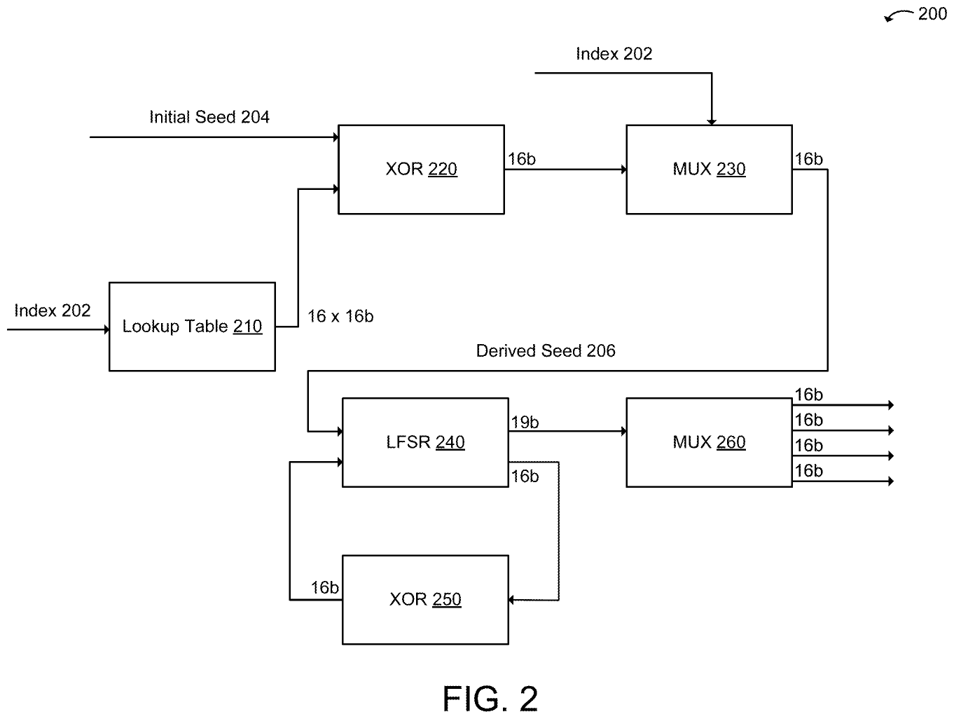

As depicted in FIG. 1, system 100 may include a controller 110 communicatively coupled to a deterministic stochastic rounder 120, which may include pseudo-random number generator 122 with one or more components, including lookup table 210, XOR operators 220 and 250, MUX operators 230 and 260, and linear-feedback shift register 240 of FIG. 2. Each component, or functional group, may be implemented via one or more electronic circuits (e.g., circuit groups). In some embodiments, any functional group (e.g., circuit group) may be combined with any other functional group on the same silicon die. In some embodiments, all functional groups may be implemented (together with or separately from controller 110) on the same die. Any or all of the functional groups may be (or include) a number of configurable logic circuits. The logic circuits of any or all functional groups can be configured by the host computer device, which may include an application-specific integrated circuit (ASIC), a finite state machine (FSM), a field-programmable gate array (FPGA), a central processing unit (CPU), a graphics processing unit (GPU), a parallel processing unit (PPU), or some other processing device, or a combination of the aforementioned processing devices. Various functional groups of deterministic stochastic rounder 120 may also be communicatively coupled to a memory 130, which may include one or more memory components, such as cache memory, dynamic randomly addressable memory (“DRAM”), static randomly addressable memory (“SRAM”), non-volatile memory (e.g., flash memory), or some other suitable data storage.

Controller 110 may receive instructions from host computer device 102 identifying a video file (or weights of a neural network) to be processed, e.g., by the file's storage location in memory 130. For example, the bit-depth of every pixel of the video file may need to be reduced from a first bit length (e.g., 10 bits) to a second bit length (e.g., 8 bits). The video file may include one or more video frames (e.g., images). In some embodiments, video frames are processed in order. In some embodiments, video frames are processed out of order.

In order to reduce the bit-length of each pixel of a given video frame, deterministic stochastic rounder 120 may be used to perform stochastic rounding. The video frame may be divided into one or more regions (e.g., blocks). In some embodiments, the video frame is divided into blocks of a first size (e.g., 64×32 pixels) according to a first scan order (e.g., horizontal scan, vertical scan). A group of blocks may represent a tile. The tile may include a number of pixels less than or equal to a period of pseudo-random number generator 122 (e.g., the number of values pseudo-random number generator 122 can generate before repeating values).

To ensure the stochastic rounding is deterministic, controller 110 may initialize pseudo-random number generator 122 based on the video frame and the tile of the frame that is to be processed. For example, a video frame may have a frame seed value (e.g., initial seed 204). In some embodiments, the frame seed value may be based on an index of the video frame in the video file. In some embodiments, the frame seed value is randomly generated for each video frame. In some embodiments, all video frames have the same frame seed value. A tile seed value (e.g., derived seed 206) may be generated based on the frame seed value. The seed value (e.g., frame seed value, tile seed value, etc.) may be used as the first value in a linear feedback shift register (LFSR) (e.g., LFSR 240).

The frame seed value may be a first value in the pseudo-random sequence of numbers generated by pseudo-random number generator 122. The derived seed value may be the k-th value after the first value in the pseudo-random sequence of numbers. The derived seed value \vec{Q}^{(k)} may be calculated based on the initial seed \vec{Q}⁽⁰⁾ (e.g., frame seed value) using the following equation: \vec{Q}^{(k)}=A^{k}⊕\vec{Q}⁽⁰⁾, where A is a transform matrix based on the LFSR (e.g., based on the taps of the LFSR) that generates the pseudo-random number sequence. In some embodiments, transformation matrices may be stored in a lookup table (e.g., lookup table 210). The transformation matrices may be indexed based on a position (e.g., (X,Y) coordinates within the video frame) of the tile (or block) within the video frame being processed. For example, a first block of a video frame may be at position (0,0), which may correspond to a first transformation matrix in the lookup table. A second block of a video frame may be at position (1,0), which may correspond to a second transformation matrix in the lookup table.

When processing a neural network (e.g., weights of each layer of a neural network, activations of a neural network, biases of a neural network, etc.), the initial seed may be based on the neural network (e.g., a neural network seed value). The index into the lookup table may be based on a position of a layer of the neural network within the neural network. The derived seed may represent a neural network layer seed value.

The processed output (e.g., reduced bit-depth video frames, reduced bit-depth neural network weights, etc.) may be stored in memory 130 and/or livestreamed over the Internet or any other suitable network, including a local area network, a wide area network, a personal area network, a public network, a private network, and the like.

FIG. 2 is a schematic block diagram of an example pseudo-random number generator 200 used for parallel, deterministic stochastic rounding, in accordance with at least some embodiments. In some embodiments, pseudo-random number generator 200 may be the same as pseudo-random number generator 122 of FIG. 1. Initialization of pseudo-random number generator 200 may begin with receiving at lookup table 210 an index 202. The index may be based on a position of the tile (or block) being processed. In some embodiments, when processing weights of a neural network, the index may be based on a position of the layer corresponding to the weights to be processed in the neural network. Based on index 202, a transformation matrix may be provided to XOR operator 220. The transformation matrix may be a square matrix with dimensions equal to the number of bits in linear-feedback shift register (LFSR) 240 (e.g., 16 bits in FIG. 2). XOR operator 220 may combine the transformation matrix and initial seed 204 (e.g., frame seed value, neural network seed value) using XOR operations to obtain a set of output bits. The output bits may be provided to MUX operator 230 along with index 202. In some embodiments, index 202 is used to obtain a tile index and a block index. For example, the block index derived from index 202 may be provided to lookup table 210, and the tile index derived from index 202 may be provided to MUX operator 230. MUX operator 230 may perform on-the-fly combinational logic to determine the next N pseudo-random numbers in the pseudo-random number sequence following the output bits of XOR operator 220 and may jump ahead in the pseudo-random number sequence a number of positions based on the tile index derived from index 202. For example, the tile index derived from index 202 may act as an offset into the pseudo-random number sequence. The output of MUX operator 230 may be derived seed 206 (e.g., tile seed value, neural network layer seed value). Derived seed 206 may be stored in LFSR 240 as an initial value of the pseudo-random number sequence. For example, derived seed 206 may have 16 bits and LFSR 240 may include 16 flip-flops. The value of the first bit of derived seed 206 may be stored in the first flip-flop of LFSR 240. The value of the second bit of derived seed 206 may be stored in the second flip-flop of LFSR 240, and so forth. After derived seed 206 has been stored in LFSR 240 (e.g., after LFSR 240 has been initialized), pseudo-random numbers may be generated by XOR operator 250, which updates the value of LFSR 240 based on its current value.

In some embodiments, LFSR 240 may generate M random numbers at a time. Each cycle, the new value of LFSR 240 may be calculated (e.g., by XOR operator 250) using an M-step transformation matrix that advances LFSR 240 by M positions in the pseudo-random number sequence. For example, LFSR 240 may be at position n in the pseudo-random number sequence. On the next cycle, after applying the M-step transformation matrix to the value stored in LFSR 240, LFSR 240 may jump to position n+M in the sequence. Some bits of the M generated pseudo-random numbers may overlap. For example, all M pseudo-random values may be represented using N+M−1 bits, where N is the number of bits in LFSR 240 and M is the number of pseudo-random number outputs each cycle (e.g., 4). In some embodiments, before LFSR 240 is transformed, M−1 bits of the value stored in LFSR 240 (e.g., M−1 least significant bits) may be stored (e.g., in M−1 flip-flops). The stored bits may be provided to MUX 260 along with the new (e.g., transformed) 16-bit value of LFSR 240. MUX 260 may select M groups of N bits from the N+M−1-bit value, with each group of N bits representing one pseudo-random number output.

For example, if LFSR 240 has 16 bits, and there are 4 pseudo-random number outputs each cycle, the 4 pseudo-random numbers may all be represented using 19 bits (e.g., 16+4−1). The first pseudo-random number may include the first 16 least significant bits of the 19-bit output of LFSR 240 (e.g., bits 0-15). The second pseudo-random number may skip the first least significant bit and include the next 16 least significant bits (e.g., bits 1-16). The third pseudo-random number may skip the first two least significant bits and include the next 16 least significant bits (e.g., bits 2-17). The fourth pseudo-random number may skip the first three least significant bits and include the next 16 least significant bits (which may be the same as the 16 most significant bits) (e.g., bits 3-18). In some embodiments, the pseudo-random numbers may be selected by most significant bits instead of least significant bits. MUX operator 260 may be used to select between the different pseudo-random numbers (e.g., by shifting and/or masking the 19-bit LFSR 240 output to obtain the desired 16-bit pseudo-random number).

In some embodiments, LFSR 240 may contain more (or fewer) flip-flops. In some embodiments, LFSR 240 may jump more (or less) than 4 positions each cycle such that there are more (or fewer) pseudo-random number outputs each cycle.

In some embodiments, a first video frame and a second video frame are processed in parallel. In some embodiments, a first tile of a video frame and a second tile of the video frame are processed in parallel. In some embodiments, a first block of a first tile of a video frame and a second block of the first tile of the video frame are processed in parallel. To enable parallel processing, the first block (tile, video frame, neural network layer, etc.) may be processed by a first LFSR (or set of LFSRs), and the second block (tile, video frame, neural network layer, etc.) may be processed by a second LFSR (or set of LFSRs). Each LFSR may be initialized based on the initial seed (e.g., frame seed value, neural network seed value) and derived seed (e.g., tile seed value, neural network layer seed value) corresponding to the block being processed.

During each cycle of processing (e.g., clock cycle), M values (e.g., pixel values, neural network weight values, etc.) may be compared to the M pseudo-random number outputs of LFSR 240. Each value may be split into two sets of bits: the rounded bits and the truncated bits. The truncated bits may be the least significant bits of the value, and the number of bits to truncate may be equal to the difference between the high bit-depth value and the low bit-depth value. The remaining bits are included in the rounded bits. For example, if the bit-depth of the set of values being processed is being reduced from 10 bits to 8 bits, the truncated bits would be the 2 least significant bits of the original value, and the rounded bits would be the 8 most significant bits of the original value.

The value may be rounded based on the output (or one of the outputs) of the LFSR 240. For example, if the value of the truncated bits is greater than the value of an equal number of most significant bits (or least significant bits) of the output of LFSR 240, the rounded bits may be rounded away from zero. If the value of the truncated bits is less than or equal to an equal number of most significant bits (or least significant bits) of the output of LFSR 240, the rounded bits may be rounded toward zero. Because of the uniform distribution of the output of the random number generator, there will be no accumulation of rounding errors in the set of values to be processed, regardless of whether the set of values has a uniform or non-uniform distribution. Because there are no dependencies between neighboring values or accumulated errors, multiple sets of values (e.g., multiple blocks, multiple tiles, multiple video frames, multiple layers of weights, etc.) may be processed in parallel.

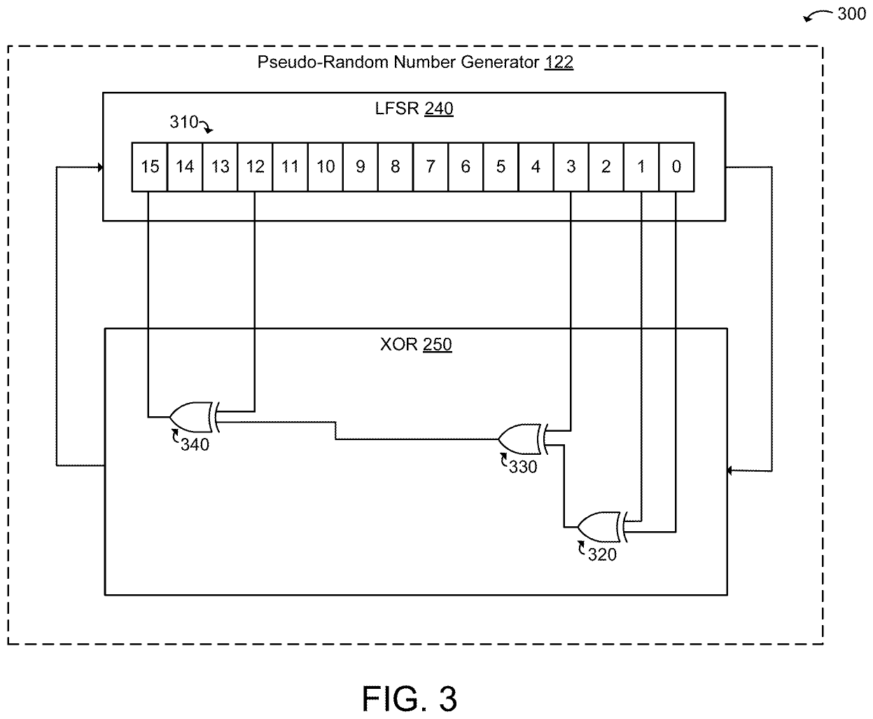

FIG. 3 is a schematic block diagram 300 of a linear-feedback shift register of the pseudo-random number generator 122 of FIG. 1, in accordance with at least some embodiments. In some embodiments, LFSR 240 may include 16 flip-flops 310 (labelled 0-15 in FIG. 3, with flip-flop 0 being the least significant bit of the value represented by LFSR 240 and flip-flop 15 being the most significant bit). At each clock cycle, the values of each flip-flop may shift to the right by one (e.g., the value of flip-flop 15 is stored in flip-flop 14, the value of flip-flop 14 is stored in flip-flop 13, and so forth, with the value of flip-flop 0 being discarded) and a new value may be calculated for flip-flop 15. The new value for flip-flop 15 may be calculated as a linear combination of some of the flip-flops 310 (e.g., “taps”). In some embodiments, LFSR 240 has taps at bits/flip-flops 0, 1, 3, and 12. The bit values of each tap may be combined using XOR operator 250. For example, XOR operator 250 may include a first XOR gate 320 to combine the values of flip-flops 0 and 1. The result of XOR gate 320 may be combined with the value of flip-flop 3 at XOR gate 330. The result of XOR gate 330 may be combined with the value of flip-flop 12 at XOR gate 340. The result of XOR gate 340 may be stored in flip-flop 15. This process may repeat to generate each subsequent pseudo-random number in the sequence of pseudo-random numbers.

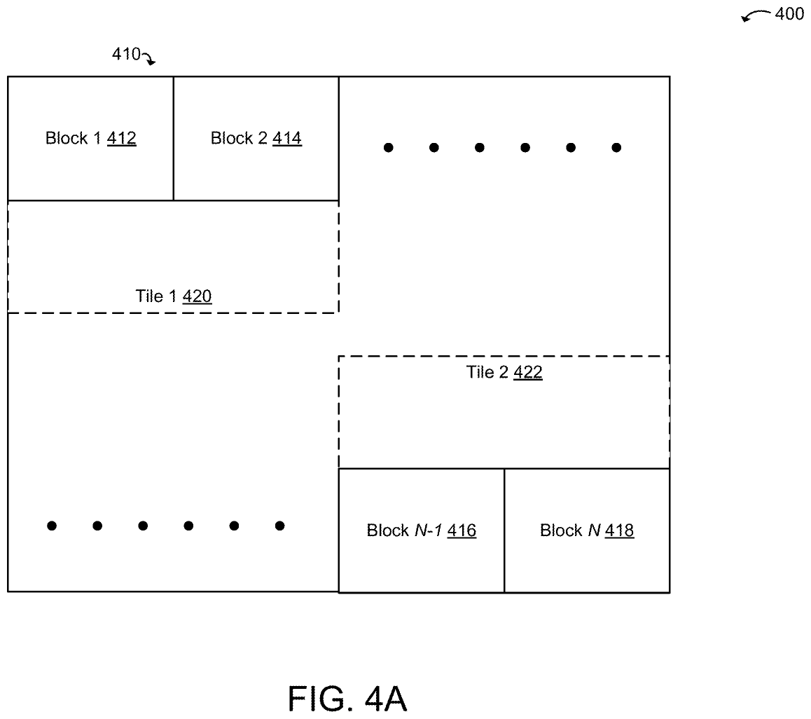

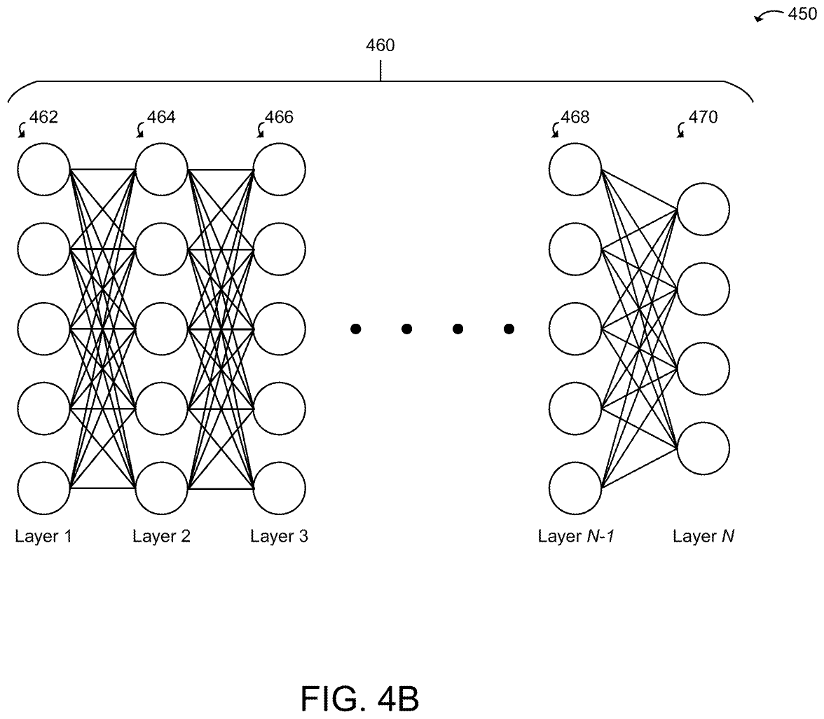

FIG. 4A is a block diagram 400 of regions of a video frame 410 to be processed in parallel, in accordance with at least some embodiments. Video frame 410 may be divided into one or more blocks (e.g., block 1 412, block 2 414, block N-1 416, block N 418, etc.). One or more blocks may be grouped into a tile (e.g., tile 1 420, tile 2 422, etc.). One or more blocks (e.g., block 1 412 and block 2 414) of video frame 410 may be processed in parallel. For example, pixel values of block 1 412 may be compared to random numbers generated by a first pseudo-random number generator while pixel values of block 2 414 are being compared to random numbers generated by a second pseudo-random number generator in parallel. In some embodiments, pixel values of a first tile (e.g., tile 1 420) may be processed while pixel values of a second tile (e.g., tile 2 422) are being processed in parallel. After being processed (e.g., after every pixel value of the video frame has been reduced from a first bit-length to a smaller second bit-length), the video frame may appear substantially similar to the original video frame, but much less storage space may be required to store in memory or transmit the video frame.

FIG. 4B is a block diagram 450 of layers of a neural network 460 whose weights are to be processed in parallel, in accordance with at least some embodiments. Neural network 460 may include one or more layers (e.g., layer 1 462, layer 2 464, layer 3 466, layer N-1 468, layer N 470, etc.). Each layer may have one or more associated weights. Each weight may represent how much influence (e.g., “weight”) is given to the output/input of a particular node in a layer. For example, layer 1 462 may include 5 nodes, and each node may be connected to all 5 nodes of layer 2 464. Therefore, there may be 25 weights associated with layer 2 464. There may be another 25 weights associated with layer 3 466 (e.g., between nodes of layer 2 464 and layer 3 466). In some embodiments, layers of neural network 460 may not have the same number of nodes. For example, layer N-1 468 may include 5 nodes and layer N 470 may include 4 nodes. As such, layer N 470 may have 20 associated weights instead of 25. In some embodiments, layers of the neural network have more (or fewer) nodes in each layer. Each weight may originally be represented by, for example, a 16-bit value. After processing, each weight may be represented by an 8-bit value. The neural network weights represented by 8 bits may require less memory space for storage and/or for maintaining in memory during inference of the neural network. The outputs of the neural network with the reduced bit-length (e.g., quantized) weights may be similar to the outputs of the neural network with the original bit-length weights. In some embodiments, the outputs of the neural network with reduced bit-length weights may be less accurate than the outputs of the neural network with the original bit-length weights, but the space savings and decreased inference latency (e.g., as a result of performing operations on smaller values), may be an acceptable tradeoff.

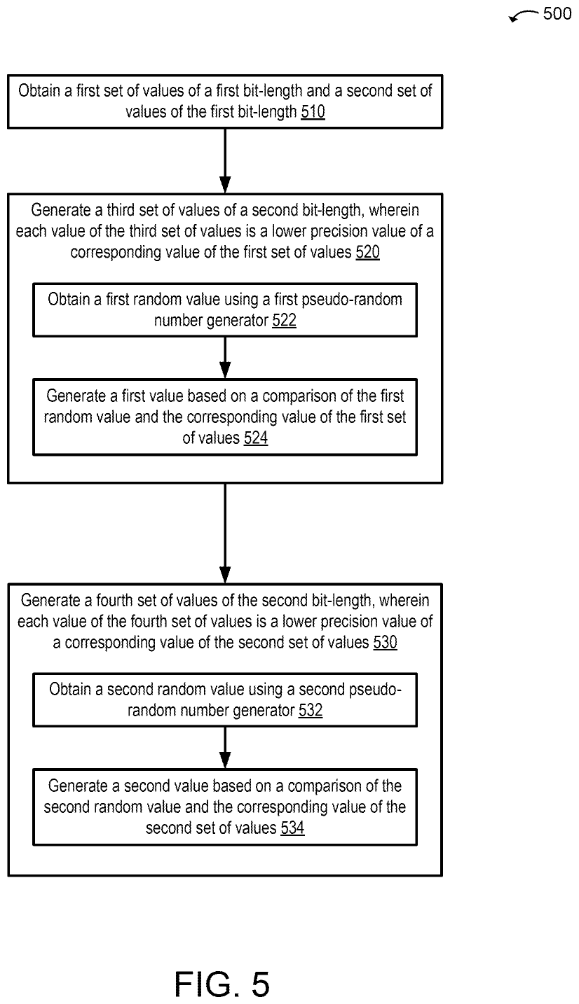

FIG. 5 is a flow diagrams of example methods 500 of performing deterministic stochastic rounding, in accordance with at least some embodiments. In some embodiments, method 500 may be performed by deterministic stochastic rounder 120 and/or pseudo-random number generator 122 of FIG. 1. In some embodiments, method 500 may be performed by one or more circuits (e.g., circuit groups) that may communicate with one or more memory devices. In some embodiments, at least some operations of method 500 may be performed by multiple (e.g., parallel) hardware threads, each thread executing one or more individual functions, routines, subroutines, or operations of the methods. In some embodiments, processing threads implementing method 500 may be synchronized (e.g., using semaphores, critical sections, and/or other thread synchronization mechanisms). Alternatively, hardware threads implementing method 500 may be executed asynchronously with respect to each other. Various operations of method 500 may be performed in a different order compared with the order shown in FIG. 5. Some operations of method 500 may be performed concurrently with other operations. In some embodiments, one or more operations shown in FIG. 5 may not be performed.

Method 500 may be performed during encoding of a video file in AV1 codec format, VP9 codec format, H.264 codec format, H.265 codec format, or any other suitable video codec format. Method 500 may be performed during quantization of a neural network (e.g., decreasing precision of weights, biases, activations, etc. of a neural network). At block 510, the one or more circuits performing method 500 may obtain a first set of values of a first bit-length and a second set of values of the first bit-length. In some embodiments, the first set of values may correspond to a first region of an image (e.g., video frame) to be processed, and the second set of values may correspond to a second region of the image to be processed. The first set of values and the second set of values may correspond to pixel values within the corresponding region of the video frame. The first pseudo-random number generator may be initialized based on a position of the first region within the image. The second pseudo-random number generator may be initialized based on a position of the second region within the image. In some embodiments, the first set of values corresponds to weights of a first layer of a neural network, and the second set of values may correspond to weights of a second layer of the neural network. The first pseudo-random number generator may be initialized based on an identifier of the first layer of the machine learning model. The second pseudo-random number generator may be initialized based on an identifier of the second layer of the machine learning model. For example, the first layer and the second layer may have corresponding identifiers based on a position of the layer in an ordered set of layers corresponding to the neural network.

At block 520, the one or more circuits may generate a third set of values of a second bit-length, wherein each value of the third set of values is a lower precision value of a corresponding value of the first set of values. For example, the first set of values may be pixel values with a bit-depth of 10-bits. The one or more circuits may convert each pixel value of the first set to a corresponding pixel value with a bit-depth of 8 bits (or another number of bits fewer than 10). In some embodiments, the first set of values may be weights of a neural network with a bit-depth of 16-bits. The one or more circuits may convert each weight of the first set to a corresponding weight with a bit-depth of 8 bits (or another number of bits fewer than 16).

To generate the third set of values, at block 522, the one or more circuits may obtain a first random value using a first pseudo-random number generator. At block 524, the one or more circuits may generate a first value based on a comparison of the first random value and the corresponding value of the first set of values. In some embodiments, the one or more circuits may approximate the corresponding value of the first set of values using stochastic rounding based on the first random value. For example, if the first random value is greater than a portion (e.g., the N most significant bits, the N least significant bits) of the corresponding value of the first set of values, the first value may be rounded up (e.g., away from zero). If the first random value is less than and/or equal to the portion of the corresponding value of the first set of values, the first value may be rounded down (e.g., toward zero). In some embodiments, the first value may be rounded up if the portion of the corresponding value is less than and/or equal to the first random value, and vice versa.

At block 530, the one or more circuits may generate a fourth set of values of the second bit-length, wherein each value of the fourth set of values is a lower precision value of a corresponding value of the second set of values. To generate the fourth set of values, the one or more circuits may, at block 532, obtain a second random value using a second pseudo-random number generator. At block 534, the one or more circuits may generate a second value based on a comparison of the second random value and the corresponding value of the second set of values. In some embodiments, generating the third set of values and the fourth set of values is performed in parallel.

Images and videos generated applying one or more of the techniques disclosed herein may be displayed on a monitor or other display device. In some embodiments, the display device may be coupled directly to the system or processor generating or rendering the images or videos. In other embodiments, the display device may be coupled indirectly to the system or processor, such as via a network. Examples of such networks include the Internet, mobile telecommunications networks, a WIFI network, as well as any other wired and/or wireless networking system. When the display device is indirectly coupled, the images or videos generated by the system or processor may be streamed over the network to the display device. Such streaming allows, for example, video games or other applications, which render images or videos, to be executed on a server or in a data center and the rendered images and videos to be transmitted and displayed on one or more user devices (such as a computer, video game console, smartphone, other mobile devices, etc.) that are physically separate from the server or data center. Hence, the techniques disclosed herein can be applied to enhance the images or videos that are streamed and to enhance services that stream images and videos, such as NVIDIA GeForce Now (GFN), Google Stadia, and the like.

Furthermore, images and videos generated applying one or more of the techniques disclosed herein may be used to train, test, or certify deep neural networks (DNNs) used to recognize objects and environments in the real world. Such images and videos may include scenes of roadways, factories, buildings, urban settings, rural settings, humans, animals, and any other physical object or real-world setting. Such images and videos may be used to train, test, or certify DNNs that are employed in machines or robots to manipulate, handle, or modify physical objects in the real world. Furthermore, such images and videos may be used to train, test, or certify DNNs that are employed in autonomous vehicles to navigate and move the vehicles through the real world. Additionally, images and videos generated applying one or more of the techniques disclosed herein may be used to convey information to users of such machines, robots, and vehicles.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in an illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, the number of items in a plurality is at least two, but it can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause the computer system to perform operations described herein. In at least one embodiment, a set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium stores instructions and a main central processing unit (“CPU”) executes some of the instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to same the extent as if each reference were individually and specifically indicated to be incorporated by reference and were set forth in its entirety herein.

In description and claims, the terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to actions and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transform that electronic data into other electronic data that may be stored in registers and/or memory. As non-limiting examples, a “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously, or intermittently. In at least one embodiment, the terms “system” and “method” are used herein interchangeably insofar as the system may embody one or more methods, and methods may be considered a system.

In the present document, references may be made to obtaining, acquiring, receiving, or inputting analog or digital data into a subsystem, computer system, or computer-implemented machine. In at least one embodiment, the process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or an interprocess communication mechanism.

Although descriptions herein set forth example embodiments of described techniques, other architectures may be used to implement described functionality, and are intended to be within the scope of this disclosure. Furthermore, although specific distributions of responsibilities may be defined above for purposes of description, various functions and responsibilities might be distributed and divided in different ways, depending on the circumstances.

Furthermore, although the subject matter has been described in language specific to structural features and/or methodological acts, it is to be understood that the subject matter claimed in appended claims is not necessarily limited to specific features or acts described. Rather, specific features and acts are disclosed as exemplary forms of implementing the claims.

What is claimed is:

1. A method comprising:
obtaining a first set of values of a first bit-length and a second set of values of the first bit-length;
generating a third set of values of a second bit-length, wherein each value of the third set of values is a lower precision value of a corresponding value of the first set of values, wherein the generating the third set of values comprises:
obtaining a first random value using a first pseudo-random number generator; and
generating a first value based on a comparison of the first random value and the corresponding value of the first set of values; and
generating a fourth set of values of the second bit-length, wherein each value of the fourth set of values is a lower precision value of a corresponding value of the second set of values, wherein the generating the fourth set of values comprises:
obtaining a second random value using a second pseudo-random number generator; and
generating a second value based on a comparison of the second random value and the corresponding value of the second set of values; and
wherein the generating the third set of values and the generating the fourth set of values is performed in parallel.

2. The method of claim 1, wherein the generating the first value based on the comparison of the first random value and the corresponding value of the first set of values comprises approximating the corresponding value of the first set of values using stochastic rounding based on the first random value.

3. The method of claim 1, wherein the first set of values corresponds to a first region of an image and the second set of values corresponds to a second region of the image.

4. The method of claim 3, wherein the first pseudo-random number generator is initialized based on a position of the first region and the second pseudo-random number generator is initialized based on a position of the second region.

5. The method of claim 1, wherein the first set of values corresponds to weights of a first layer of a machine learning model and the second set of values corresponds to weights of a second layer of the machine learning model.

6. The method of claim 5, wherein the first pseudo-random number generator is initialized based on an identifier of the first layer and the second pseudo-random number generator is initialized based on an identifier of the second layer.

7. The method of claim 1, wherein the first pseudo-random number generator is a 16-bit linear-feedback shift register with taps at bit 13, bit 4, bit 2, and bit 1.

8. A system comprising:
a memory device; and
one or more circuit groups communicatively coupled to the memory device, the one or more circuit groups to:
obtain a first set of values of a first bit-length and a second set of values of the first bit-length;
generate a third set of values of a second bit-length, wherein each value of the third set of values is a lower precision value of a corresponding value of the first set of values, wherein to generate the third set of values the one or more circuit groups are to:
obtain a first random value using a first pseudo-random number generator; and
generate a first value based on a comparison of the first random value and the corresponding value of the first set of values; and
generate a fourth set of values of the second bit-length, wherein each value of the fourth set of values is a lower precision value of a corresponding value of the second set of values, wherein to generate the fourth set of values the one or more circuit groups are to:
obtain a second random value using a second pseudo-random number generator; and
generate a second value based on a comparison of the second random value and the corresponding value of the second set of values; and
wherein the one or more circuit groups generate the third set of values and generate the fourth set of values in parallel.

9. The system of claim 8, wherein to generate the first value based on the comparison of the first random value and the corresponding value of the first set of values the one or more circuit groups are to approximate the corresponding value of the first set of values using stochastic rounding based on the first random value.

10. The system of claim 8, wherein the first set of values corresponds to a first region of an image and the second set of values corresponds to a second region of the image.

11. The system of claim 10, wherein the first pseudo-random number generator is initialized based on a position of the first region and the second pseudo-random number generator is initialized based on a position of the second region.

12. The system of claim 8, wherein the first set of values corresponds to weights of a first layer of a machine learning model and the second set of values corresponds to weights of a second layer of the machine learning model.

13. The system of claim 12, wherein the first pseudo-random number generator is initialized based on an identifier of the first layer and the second pseudo-random number generator is initialized based on an identifier of the second layer.

14. The system of claim 8, wherein the first pseudo-random number generator is a 16-bit linear-feedback shift register with taps at bit 13, bit 4, bit 2, and bit 1.

15. A system comprising:
a memory device; and
one or more circuit groups communicatively coupled to the memory device, the one or more circuit groups comprising:
a first circuit group to:
obtain a first set of values of a first bit-length;
generate a third set of values of a second bit-length, wherein each value of the third set of values is a lower precision value of a corresponding value of the first set of values, wherein to generate the third set of values the first circuit group is to:
obtain a first random value using a first pseudo-random number generator; and
generate a first value based on a comparison of the first random value and the corresponding value of the first set of values; and
a second circuit group to:
obtain a second set of values of the first bit-length;
generate a fourth set of values of the second bit-length, wherein each value of the fourth set of values is a lower precision value of a corresponding value of the second set of values, wherein to generate the fourth set of values the second circuit group is to:
obtain a second random value using a second pseudo-random number generator; and
generate a second value based on a comparison of the second random value and the corresponding value of the second set of values; and
wherein the first circuit group and the second circuit group execute in parallel.

16. The system of claim 15, wherein to generate the first value based on the comparison of the first random value and the corresponding value of the first set of values the first circuit group is to approximate the corresponding value of the first set of values using stochastic rounding based on the first random value.

17. The system of claim 15, wherein the first set of values corresponds to a first region of an image and the second set of values corresponds to a second region of the image.

18. The system of claim 17, wherein the first pseudo-random number generator is initialized based on a position of the first region and the second pseudo-random number generator is initialized based on a position of the second region.

19. The system of claim 15, wherein the first set of values corresponds to weights of a first layer of a machine learning model and the second set of values corresponds to weights of a second layer of the machine learning model.

20. The system of claim 19, wherein the first pseudo-random number generator is initialized based on an identifier of the first layer and the second pseudo-random number generator is initialized based on an identifier of the second layer.
